(19) United States
(12) Patent Application Publication
(10) Pub. No.: US 2024/0144934 A1
(43) Pub. Date: May 2, 2024

(54) Voice Data Generation Method, Voice Data Generation Apparatus And Computer-Readable Recording Medium

(71) Applicants: Hyundai Motor Company, Seoul (KR); Kia Corporation, Seoul (KR)

(72) Inventors: Jinseok Park, Hwaseong-Si (KR); Yunkyu Lim, Hanam-Si (KR); Byeongyeol Kim, Seoul (KR); Younglo Lee, Seoul (KR)

(21) Appl. No.: 18/383,261

(22) Filed: Oct. 24, 2023

(30) Foreign Application Priority Data
Oct. 31, 2022 (KR) 10-2022-0142064

(51) Int. Cl. G10L 17/04

(52) U.S. Cl. CPC G10L 17/04

(57) ABSTRACT

A voice data generation method may include: determining a number of a plurality of speakers to be used for voice data generation; determining a number of voice segments for each of the plurality of speakers; and arranging the determined number of voice segments for each of the plurality of speakers. The arranging of the determined number of voice segments may include, based on an end point of a voice segment of a speaker of the plurality of speakers, determining a start point of a voice segment of another speaker.

### CROSS-REFERENCE TO RELATED APPLICATION

This application is based on and claims priority to Korean Patent Application No. 10-2022-0142064, filed on Oct. 31, 2022 in the Korean Intellectual Property Office, the disclosure of which is incorporated herein by reference.

### TECHNICAL FIELD

The disclosure relates to a voice data generation method, a voice data generation apparatus, and a computer-readable recording medium that may generate voice data used for a learning process.

### BACKGROUND

What is uttered by a speaker may be converted into text and be recorded by storing the converted text by using a speech recognition technology. Also, what is intended by the speaker may be identified by applying a natural language understanding technology to the converted text.

Such a speech recognition technology may be applied to a wide variety of fields such as control of electronic device, question answering service, taking minutes of a meeting, recording calls at a call center, medical records, and the like.

Meanwhile, when a plurality of speakers exist, an operation of separating uttered voice signals for each speaker may be required for accurate speech recognition.

For example, a trained speaker diarization model may be used to perform speaker diarization described above. To train a speaker diarization model, a large amount of voice data in which voice data of a plurality of speakers are mixed may be required.

Descriptions in this background section are provided to enhance understanding of the background of the disclosure, and may include descriptions other than those of the prior art already known to those of ordinary skill in the art to which this technology belongs.

### SUMMARY

The following summary presents a simplified summary of certain features. The summary is not an extensive overview and is not intended to identify key or critical elements.

An aspect of the disclosure provides a voice data generation method, a voice data generation apparatus, and a computer-readable recording medium storing a program for implementing the voice data generation method that may generate natural voice data similar to conversations among a plurality of actual speakers.

Additional aspects of the disclosure will be set forth in part in the description which follows and/or may be learned by practice of the disclosure.

A method performed by a computing device may comprise: determining a number of a plurality of speakers to be used for voice data generation; determining a number of voice segments for each of the plurality of speakers; arranging the determined number of voice segments for each of the plurality of speakers, wherein the arranging of the determined number of voice segments comprises, based on an end point of a voice segment of a first speaker of the plurality of speakers, determining a start point of a voice segment of a second speaker; and generating, based on the arranging, voice data.

The arranging of the determined number of voice segments may comprise arranging the start point of the voice segment of the second speaker at a position spaced apart from the end point of the voice segment of the first speaker by an arbitrary time interval.

The arbitrary time interval may be determined according to a probability distribution selected from a group of probability distributions, wherein the group of probability distributions comprises at least one of: a normal distribution, a continuous uniform distribution, or a Student's t-distribution.

The arranging of the determined number of voice segments may comprise arranging the start point of the voice segment of the second speaker before or after the end point of the voice segment of the first speaker.

The arranging of the determined number of voice segments may comprise arranging first voice segments of the plurality of speakers, wherein the first voice segments are associated with a first index, and after completing the arranging of the first voice segments, arranging second voice segments of the plurality of speakers, wherein the second voice segments are associated with a second index.

Each of the arranged voice segments may be labeled with a tag indicating a speaker of the plurality of speakers.

The arranging of the determined number of voice segments may comprise: arranging a plurality of first voice segments of the plurality of speakers, wherein the plurality of first voice segments are associated with a first index, and wherein at least two of the plurality of first voice segments are arranged based on: a first time offset associated with at least one probability distribution; and an end point of a preceding one of the at least two of the plurality of first voice segments; and arranging a plurality of second voice segments of the plurality of speakers, wherein the plurality of second voice segments are associated with a second index, and wherein at least two of the plurality of second voice segments are arranged based on: a second time offset associated with the at least one probability distribution; and an end point of a preceding one of the at least two of the plurality of second voice segments. A voice segment of the plurality of second voice segments that precedes the remaining voice segments of plurality of second voice segments may be arranged based on: a third time offset associated with the at least one probability distribution; and an end point of a last voice segment of the plurality of first voice segments.

An apparatus may comprise: at least one processor; and at least one memory storing instructions that, when executed by the at least one processor, cause the apparatus to: determine a number of a plurality of speakers to be used for voice data generation; determine a number of voice segments for each of the plurality of speakers; arrange the determined number of voice segments for each of the plurality of speakers, wherein arranging the determined number of voice segments comprises, based on an end point of a voice segment of a first speaker of the plurality of speakers, determining a start point of a voice segment of a second speaker; generate, based on the arranging, voice data; and train, based on the generated voice data, a learning model associated with speaker diarization.

The instructions, when executed by the at least one processor, may cause the apparatus to arrange the start point of the voice segment of the second speaker at a position spaced apart from the end point of the voice segment of the first speaker by an arbitrary time interval.

The arbitrary time interval may be determined according to a probability distribution selected from a group of probability distributions, wherein the group of probability distributions comprises at least one of: a normal distribution, a continuous uniform distribution, or a Student's t-distribution.

The instructions, when executed by the at least one processor, may cause the apparatus to arrange the start point of the voice segment of the second speaker before or after the end point of the voice segment of the first speaker.

The instructions, when executed by the at least one processor, may cause the apparatus to arrange first voice segments of the plurality of speakers, wherein the first voice segments are associated with a first index, and after completing arrangement of the first voice segments, arrange second voice segments of the plurality of speakers, wherein the second voice segments are associated with a second index.

Each of the arranged voice segments may be labeled with a tag indicating a speaker of the plurality of speakers.

The instructions, when executed by the at least one processor, may cause the apparatus to arrange the determined number of voice segments by: arranging a plurality of first voice segments of the plurality of speakers, wherein the plurality of first voice segments are associated with a first index, and wherein at least two of the plurality of first voice segments are arranged based on: a first time offset associated with at least one probability distribution; and an end point of a preceding one of the at least two of the plurality of first voice segments; and arranging a plurality of second voice segments of the plurality of speakers, wherein the plurality of second voice segments are associated with a second index, and wherein at least two of the plurality of second voice segments are arranged based on: a second time offset associated with the at least one probability distribution; and an end point of a preceding one of the at least two of the plurality of second voice segments. A voice segment of the plurality of second voice segments that precedes the remaining voice segments of plurality of second voice segments may be arranged based on: a third time offset associated with the at least one probability distribution; and an end point of a last voice segment of the plurality of first voice segments.

A computer-readable recording medium storing instructions that, when executed, may cause: determining a number of a plurality of speakers to be used for voice data generation; determining a number of voice segments for each of the plurality of speakers; arranging the determined number of voice segments for each of the plurality of speakers, wherein the arranging of the determined number of voice segments comprises, based on an end point of a voice segment of a first speaker of the plurality of speakers, determining a start point of a voice segment of a second speaker; and generating, based on the arranging, voice data.

The instructions, when executed by the at least one processor, may cause one or more operations and/or implement one or more features described herein.

The arranging of the determined number of voice segments may comprise arranging the start point of the voice segment of the second speaker at a position spaced apart from the end point of the voice segment of the first speaker by an arbitrary time interval.

The arbitrary time interval may be determined according to a probability distribution selected from a group of probability distributions, wherein the group of probability distributions comprises at least one of: a normal distribution, a continuous uniform distribution, or a Student's t-distribution.

The arranging of the determined number of voice segments may comprise arranging the start point of the voice segment of the second speaker before or after the end point of the voice segment of the first speaker.

The arranging of the determined number of voice segments may comprise arranging first voice segments of the plurality of speakers, wherein the first voice segments are associated with a first index, and after completing the arranging of the first voice segment, arranging second voice segments of the plurality of speakers, wherein the second voice segments are associated with a second index.

Each of the arranged voice segments may be labeled with a tag indicating a speaker of the plurality of speakers.

These and other features and advantages are described in greater detail below.

### BRIEF DESCRIPTION OF THE DRAWINGS

These and/or other aspects of the disclosure will become apparent and more readily appreciated from the following description, taken in conjunction with the accompanying drawings of which:

FIG. 1 is a diagram illustrating an example where a speaker diarization technology is applied;

FIG. 2 is a diagram illustrating an example of voice signals where speaker diarization is applied;

FIG. 3 is a diagram illustrating a form of training data required for speaker diarization;

FIG. 4 is a block diagram briefly illustrating a configuration of a voice data generation apparatus;

FIG. 5 is a diagram illustrating voice segments used for generation of voice data;

FIG. 6 is a diagram illustrating an existing algorithm for generation of voice data;

FIG. 7 is a diagram illustrating voice data generated through an existing algorithm;

FIG. 8 is a flowchart illustrating a voice data generation method;

FIG. 9 is a flowchart illustrating detailed operations of arranging voice segments, in a voice data generation method of FIG. 8;

FIG. 10 is a diagram illustrating voice data generated according to a voice data generation method;

FIG. 11 is a diagram illustrating an example of voice data generated according to an existing method;

FIG. 12 is a diagram illustrating an example of voice data generated according to a method; and

FIGS. 13 to 16 are graphs illustrating features of voice data generated according to an existing method, features of voice data generated according to an example method, and features of an actual conversation.

### DETAILED DESCRIPTION

Various examples described in the specification and configurations shown in the accompanying drawings are exemplary, and various modifications may replace one or more examples, features, and the drawings of the present disclosure at the time of filing of the present application.

Terminologies used herein are for the purpose of describing particular embodiment(s) only and is not intended to limit the present disclosure. It is to be understood that the singular forms are intended to include the plural forms as well, unless the context clearly dictates otherwise.

It will be further understood that the terms “include”, “comprise” and/or “have” when used in this specification, specify the presence of stated features, integers, steps, operations, elements, and/or components, but do not preclude the presence or addition of one or more other features, integers, steps, operations, elements, components, and/or groups thereof.

Further, the terms such as “˜part”, “˜device”, “˜block”, “˜member”, “˜module”, and the like may refer to a unit for processing at least one function or act. For example, the terms may refer to at least a process processed by at least one hardware component, such as a field-programmable gate array (FPGA) and/or an application specific integrated circuit (ASIC), or software stored in memories or processors.

It will be understood that, although the terms first, second, etc. may be used herein to describe various elements, these elements should not be limited by these terms.

Reference numerals used for method steps are just used for convenience of explanation, but not to limit an order of the steps. Thus, unless the context clearly dictates otherwise, the written order may be practiced otherwise.

The term “at least one” used herein includes any and all combinations of the associated listed items. For example, it should be understood that the term “at least one of A, B, or C” may include only A, only B, only C, both A and B, both A and C, both B and C, or all of A, B and C.

Hereinafter, various examples of the disclosure are described in detail with reference to the accompanying drawings.

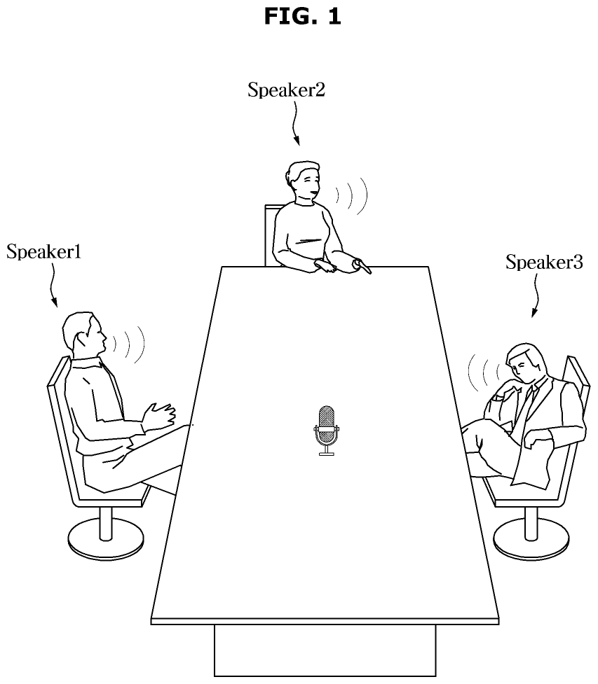

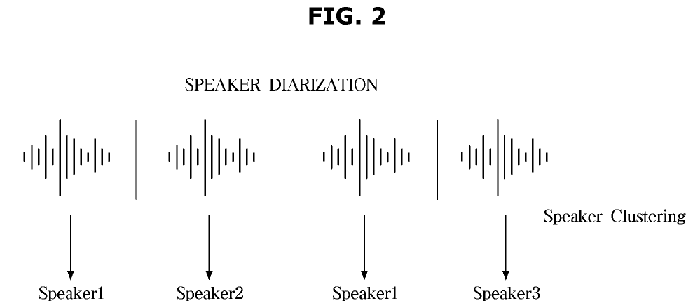

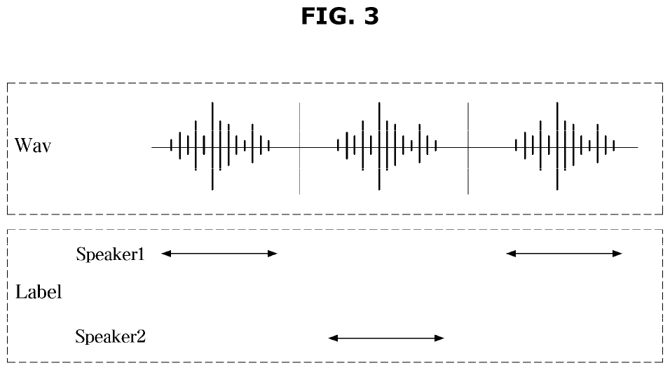

FIG. 1 is a diagram illustrating an example where a speaker diarization technology is applied. FIG. 2 is a diagram illustrating an example of voice signals where speaker diarization is applied. FIG. 3 is a diagram illustrating a form of training data required for speaker diarization.

By using a speech recognition technology, meeting minutes may be automatically taken by converting speeches (voices) uttered during a meeting in which a plurality of speakers (e.g., one or more individuals, robots, speaker devices, etc.) including a speaker 1, a speaker 2 and a speaker 3 as shown in FIG. 1 participate into text and recording the converted text.

Speech recognition may be performed by an automatic speech recognition (ASR) engine. For example, the ASR engine may extract feature vectors from a user's speech by applying a feature vector extraction method such as a cepstrum, a linear predictive coefficient (LPC), a Mel frequency cepstral coefficient (MFCC), a filter bank energy, or the like.

A recognition result may be obtained by comparing extracted feature vectors and trained reference patterns. To this end, an acoustic model for modeling and comparing signal features of voice or a language model for modeling a linguistic order of recognition vocabulary such as words or syllables may be used.

The ASR engine may convert a user's speech into text based on a learning process where deep learning and/or machine learning is applied.

To accurately recognize speeches of a plurality of speakers, an operation of separating voice signals input to a microphone for each of the speakers may be required to be performed first. For example, as shown in FIG. 2, it may be required to differentiate which one of a plurality of voice segments constituting the voice signals input to the microphone is uttered by which speaker.

The above-described operation is referred to as ‘speaker diarization’. For example, a speaker diarization model may be generated by a learning process, such as deep learning, machine learning, or the like.

To train a speaker diarization model, as shown in FIG. 3, an audio file (e.g., Way file) in which voices of a plurality of speakers are recorded and a label indicating a period of time that each of the plurality of speakers makes utterance may be required.

However, a task of collecting audio files in which conversations among a plurality of actual speakers are recorded and displaying a voice section that each of the speakers makes utterance are time-consuming and costly.

Thus, a voice data generation method and a voice data generation apparatus according to the disclosure may itself generate training data used for training a speaker diarization model by using a plurality of voice segments for each of a plurality of speakers.

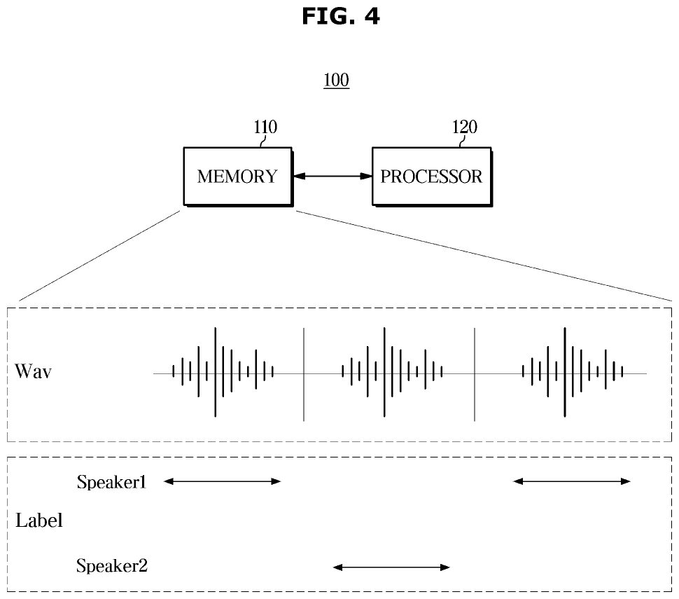

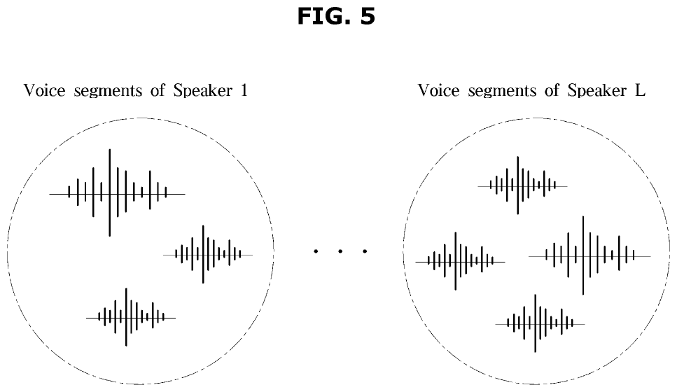

FIG. 4 is a block diagram illustrating a configuration of a voice data generation apparatus. FIG. 5 is a diagram illustrating voice segments used for generation of voice data.

Referring to FIG. 4, a voice data generation apparatus 100 may include at least one memory 110 storing a program performing operations to be described later and at least one processor 120 implementing/executing a stored program.

The processor 120 may generate voice data used for training a speaker diarization model, and the generated voice data may be stored in the memory 110.

To generate voice data, a plurality of voice segments for each of a plurality of speakers may be required as shown in FIG. 5. For example, when the number of speakers is L (which refers to that voice segments for L different speakers are prepared), and the number of voice segments for each of the L speakers is P, the number of speakers M may be set in a range from 1 to L, and the number of voice segments N may be set in a range from 1 to P in order to generate a single piece of voice data.

The processor 120 may receive and process information indicating each of the plurality of voice segments used for generation of voice data belongs to which speaker's voice segment. Accordingly, as shown in FIG. 4, the voice data generated by the processor 120 may be labeled with a voice section where each of the plurality of speakers makes utterance.

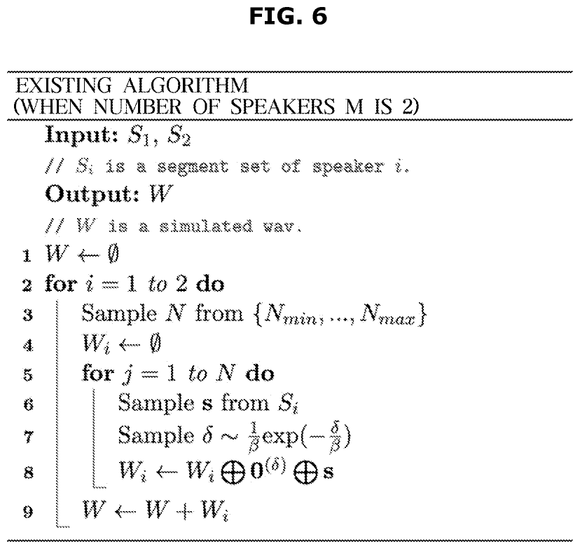

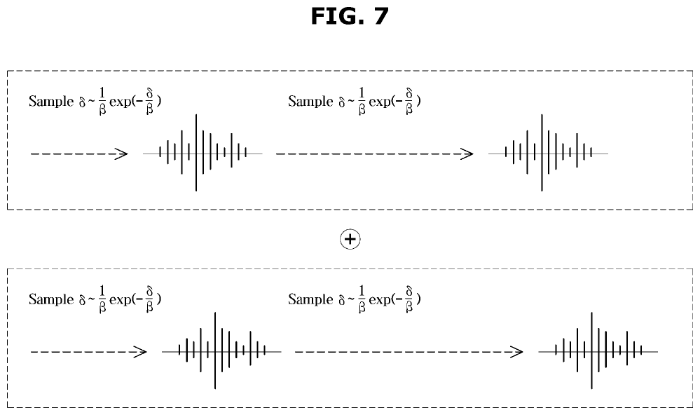

FIG. 6 is a diagram illustrating an algorithm for generation of voice data. FIG. 7 is a diagram illustrating voice data generated through an algorithm.

The algorithm shown in FIG. 6 relates to a method of generating voice data for two speakers. Referring to FIGS. 6 and 7, voice segments of a first speaker of the two speakers may be arranged first.

To this end, the number of voice segments of the first speaker to be used for generation of voice data may be determined, a silence length may be selected according to a random probability distribution, and the voice segments may be spaced apart from each other by the selected silence length when the voice segments are arranged.

After repeating the operation of arranging each of the determined number of voice segments spaced apart by the selected silence length, when voice data for the first speaker is completed by arranging all the determined number of voice segments, voice segments of another speaker may be arranged.

If voice data for each of the two speakers is generated according to the above-described operations, a single piece of voice data including voices of the plurality of speakers may be generated by summing the generated voice data.

Voice data generated according to the above method may not be natural as an actual conversation (e.g., because the voice data is synthesized after independently generating voice data for each speaker). Accordingly, when a speaker diarization model trained by using the voice data generated according to the above method is applied to a voice signal for an actual conversation, a speaker diarization result may be less accurate.

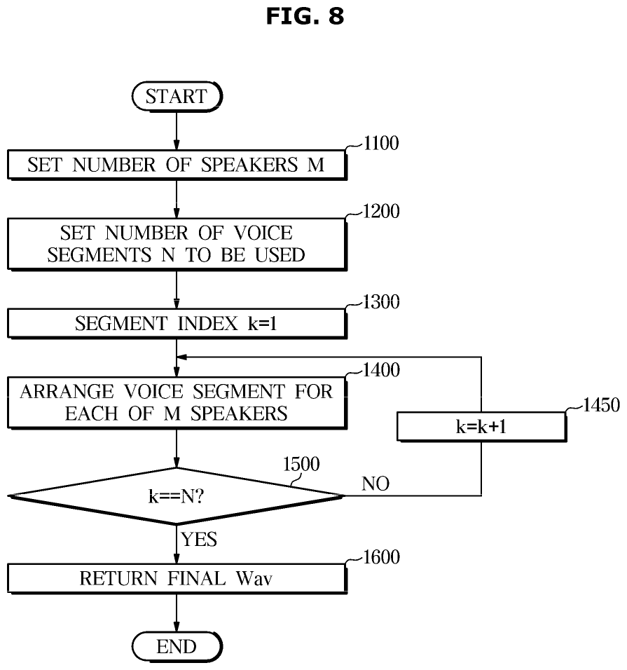

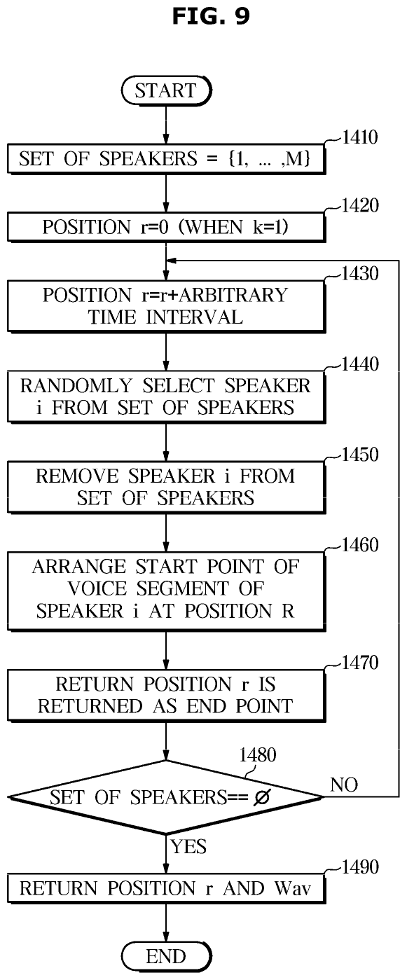

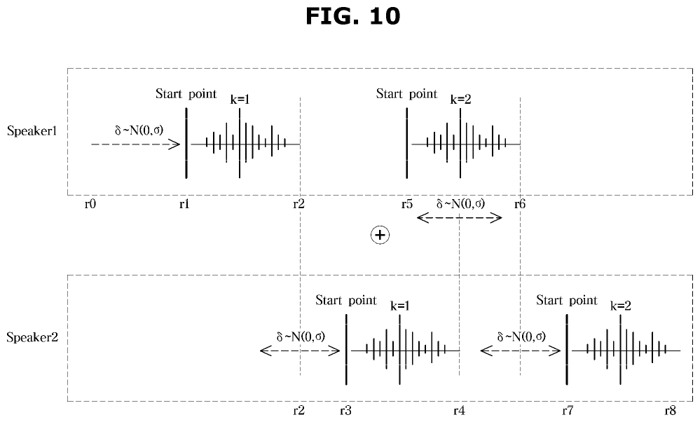

FIG. 8 is a flowchart illustrating an example voice data generation method. FIG. 9 is a flowchart illustrating example operations of arranging voice segments, in a voice data generation method of FIG. 8. FIG. 10 is a diagram illustrating example voice data generated based on a voice data generation method.

A voice data generation method may be performed by the voice data generation apparatus 100 described above. A program for performing the voice data generation method may be stored in the at least one memory 110 of the voice data generation apparatus 100, and the voice data generation method may be implemented by executing the program stored in the memory 110 by the at least one processor 120.

The above description on the voice data generation apparatus 100 may be applicable to one or more voice data generation methods described herein, even if they are not specifically described below. Also, a description on the voice data generation method may be equally applied to the voice data generation apparatus 100, even if they are not specifically described.

Referring to FIG. 8, the number of speakers M (M is an integer greater than or equal to 1) used for generation of voice data is set (1100).

If the voice data generation apparatus 100 has voice segments for the L number of speakers, M may be equal to L or less than L.

The number of voice segments N (N is an integer greater than or equal to 1) to be used is set (1200).

If the voice data generation apparatus 100 has the P number of voice segments for each of the L number of speakers, N may be equal to P or less than P. Each of the voice segments may be labeled with a tag indicating which one of the speakers makes utterance.

An index k of voice segment may be set to 1 (1300), and a voice segment of the corresponding index may be arranged for each of the M speakers (1400). The above-described arrangement of segments may be repeated until the index k becomes N (No in operation 1500), and a value of k may be increased to k+1 by 1 in the above manner (1450). If the index k becomes N (Yes in operation 1500), i.e., when arrangement of all the voice segments for each of the plurality of speakers is completed, a final audio file may be output as generated voice data (1600).

The voice segments for each of the plurality of speakers may not be independently arranged. For example, by arranging voice segments having a same index from among the segments for each of the plurality of speakers to be affected by each other's positions, voice data similar to an actual conversation, like partially overlapping voice segments of different speakers, and the like, may be generated.

Hereinafter, an operation of arranging voice segments having a same index for each of a plurality of speakers is described in detail with reference to FIGS. 9, 10 and 11.

Referring to FIG. 9, a set of speakers include a speaker 1 to a speaker M (1410), and a position r starts from 0 (1420).

A position where a speaker's voice segment starts, i.e., a position r where a start point of voice segment is arranged is spaced apart from a position r in a previous stage by an arbitrary time interval (e.g., a time offset) (1430). For example, the start point of the voice segment may be arranged at the position r spaced apart from the position r in the previous stage according to a random probability distribution.

Here, the random probability distribution may be one selected from a probability distribution group including a normal distribution, a continuous uniform distribution, and a Student's t-distribution.

A speaker i is randomly selected from the set of speakers (1440), and the speaker i is removed from the set of speakers (1450).

A voice segment of the speaker i is arranged at the position r as a start point (1460). That is, a start point of the voice segment of the speaker i is arranged at the position r.

In FIG. 10, illustrated is an example of voice segments arranged when two speakers exist, i.e., M=2. Referring to FIG. 10, it may be confirmed that a start point of a voice segment (index k=1) of speaker 1 is arranged at the position r=r1 (r1=r0+random probability distribution).

If the voice segment of the speaker i (e.g., speaker 2 different from speaker 1) is arranged, the position r is returned as an end point r2 of the corresponding voice segment (1470). If the speaker i remains in the set of speakers (No in operation 1480), the position r becomes a position r3 spaced apart from an end point r2 of the previous speaker's voice segment by an arbitrary time interval again (e.g., a time offset) (1430).

If the speaker i does not remain in the speaker set (Yes in operation 1480), the location r and Way are returned (1490).

If a voice segment of a next speaker is arranged through the same operations described above, as shown in FIG. 10, a start point of a voice segment of a next speaker (speaker 2) is arranged at the position r3 spaced apart from the end point r2 of the voice segment of the previous speaker (speaker 1) by an arbitrary time interval (e.g., a time offset).

Referring again to FIGS. 8 and 9, when the arrangement of voice segments having the index k (k=1) is completed, voice segments having an index k (k=2) are arranged in operation 1400. When arranging voice segments having an index k (k=N) is completed (Yes in operation 1500), a final audio file is returned (1600).

Referring to FIG. 10 together, the start point of the voice segment of the speaker 1 having the index k (k=2) may be located at a position r5 spaced apart from an end point r4 of a voice segment of the speaker 2 having the index k (k=1) by an arbitrary time interval (e.g., a time offset).

A start point of a voice segment of a next speaker may be located before an end point of a voice segment of a previous speaker in time, for example, within a time interval (e.g., a time offset as shown in FIG. 10). In an example, the position r5 may be earlier than the position r4 in time, and thus a voice segment of the speaker 1 having the index k (k=2) and a voice segment of the speaker 2 having the index k (k=1) overlap with each other (e.g., at least in part).

A start point of a voice segment of a next speaker may be located after an end point of a voice segment of a previous speaker in time, for example, within a time interval (e.g., a time offset as shown in FIG. 10). The start point of the voice segment of the speaker 2 having the index k (k=2) may be located at a position r7 spaced apart from an end point r6 of the voice segment of the speaker 1 having the index k (k=2) by an arbitrary time interval (e.g., a time offset).

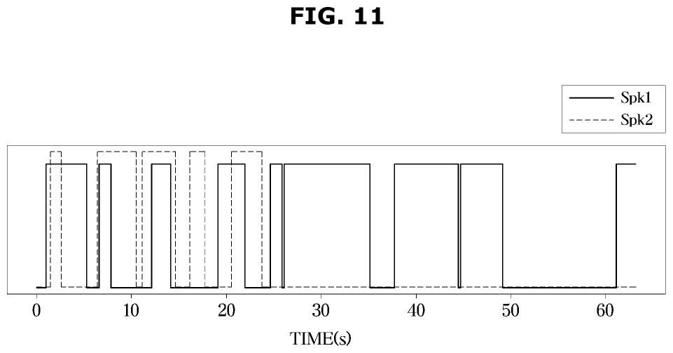

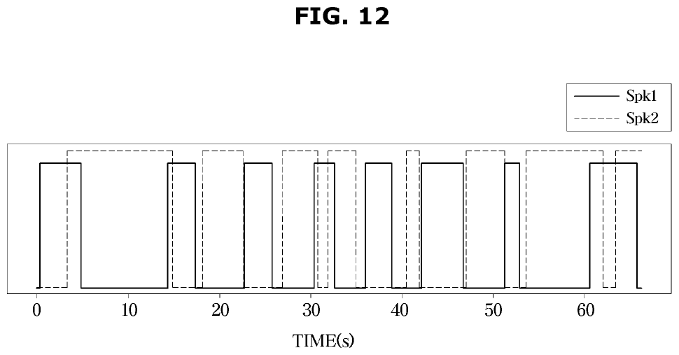

FIG. 11 is a diagram illustrating an example of voice data generated according to an existing method. FIG. 12 is a diagram illustrating an example of voice data generated according to an example method.

FIG. 11 illustrates voice data generated by arranging voice segments of two speakers according to an existing method, and FIG. 12 illustrates voice data generated by arranging voice segments of two speakers based on a voice data generation method according to an embodiment.

Comparing FIG. 11 and FIG. 12, in the voice data generated according to an existing method, voice segments of a speaker 1 and voice segments of a speaker 2 partially overlap only in a certain time period, and only the voice segments of the speaker 1 exist after a certain point in time.

On the other hand, in the voice data generated based on an example voice data generation method, utterances of the two speakers are appropriately overlapped or separated over the entire time period. That is, it may be confirmed that natural voice data more similar to an actual conversation may be generated based on the example voice data generation method.

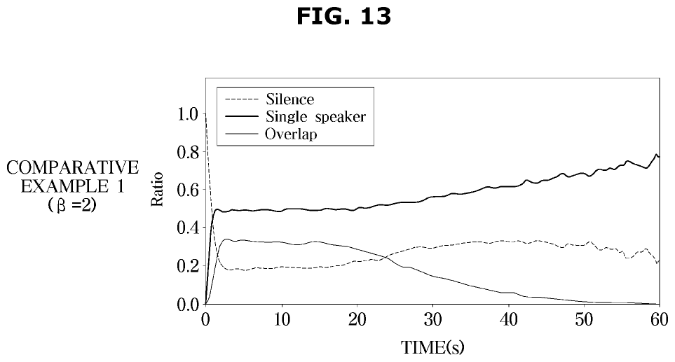

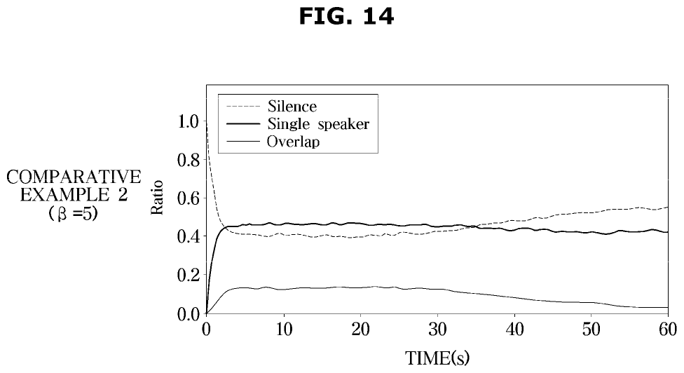

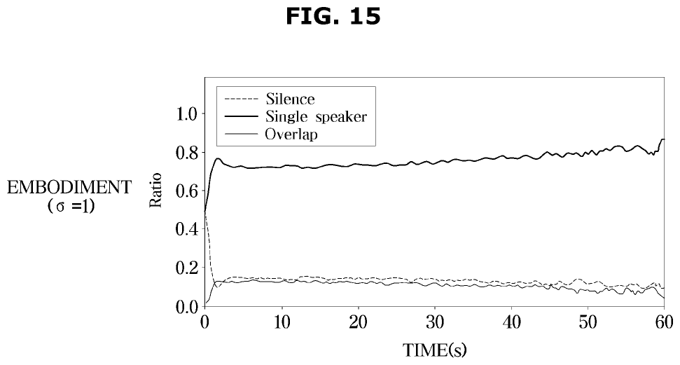

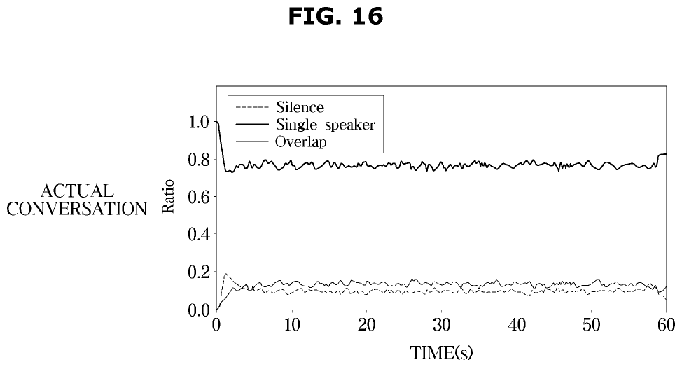

FIG. 13 shows a graph illustrating features of voice data generated according to Comparative Example 1. FIG. 14 shows a graph illustrating features of voice data generated according to Comparative Example 2. FIG. 15 shows a graph illustrating features of voice data generated according to an example method. FIG. 16 shows a graph illustrating features of an actual conversation.

FIGS. 13 and 14 are graphs illustrating a ratio among a silence period, a speech period of a single speaker and an overlap period in voice data generated according to Comparative Example 1 and Comparative Example 2, respectively.

FIG. 15 is a graph illustrating a ratio among a silence period, a speech period of a single speaker and an overlap period in voice data generated according to an example method, and FIG. 16 illustrates a result of statistics obtained by analyzing actual conversations.

As described above, voice segments may be arranged according to a probability distribution of

$$δ ∼ \frac{1}{β} exp ( - \frac{δ}{β} ) .$$

Here, β is an integer value, and a silence period tends to be longer as the value of β increases.

FIG. 13 illustrates features of voice data generated by setting 13 as 2, and FIG. 14 illustrates features of voice data generated by setting β as 5. As described above, it may be confirmed that a silence period becomes longer as a value of β increases.

FIG. 15 relates to voice data generated by arranging voice segments according to a probability distribution of

$$δ ∼ N ( 0 , σ ) ( σ = 1 ) .$$

Comparing the features of the voice data shown in the graphs of FIGS. 13, 14, 15 and 16, it may be confirmed that the voice data generated based on the voice data generation method according to the example of FIG. 15 has the most similar features to the voice data of an actual conversation.

According to an embodiment of the disclosure, a voice data generation method may include: setting a number of a plurality of speakers to be used for generation of voice data; setting a number of voice segments for each of the plurality of speakers; and arranging the set number of voice segments for each of the plurality of speakers. The arranging of the set number of voice segments may include, based on an end point of a voice segment of a speaker of the plurality of speakers, determining a start point of a voice segment of another speaker.

The arranging of the set number of voice segments may include arranging the start point of the voice segment of the other speaker at a position spaced apart from the end point of the voice segment of the speaker by an arbitrary time interval.

The arbitrary time interval may be determined according to a probability distribution selected from a group of probability distributions including a normal distribution, a continuous uniform distribution, and a Student's t-distribution.

The arranging of the set number of voice segments may include arranging the start point of the voice segment of the other speaker before or after the end point of the voice segment of the speaker.

The arranging of the set number of voice segments may include arranging voice segments having a same index for each of the plurality of speakers, and in response to completing the arrangement of the voice segments having the same index, arranging voice segments having a next index.

The arranged voice segments may be labeled with a tag indicating which speaker's voice segment from among the plurality of speakers is.

The voice data generated by arranging the set number of voice segments for each of the plurality of speakers may be used for training for speaker diarization.

According to an embodiment of the disclosure, a voice data generation apparatus may include: at least one processor configured to generate voice data including voices of a plurality of speakers; and at least one memory configured to store the generated voice data. The at least one processor may be configured to: set a number of the plurality of speakers to be used for generation of the voice data, set a number of voice segments for each of the plurality of speakers, and arrange the set number of voice segments for each of the plurality of speakers. Arranging the set number of voice segments may include, based on an end point of a voice segment of a speaker of the plurality of speakers, determining a start point of a voice segment of another speaker.

The at least one processor may be configured to arrange the start point of the voice segment of the other speaker at a position spaced apart from the end point of the voice segment of the speaker by an arbitrary time interval.

The arbitrary time interval may be determined according to a probability distribution selected from a group of probability distributions including a normal distribution, a continuous uniform distribution, and a Student's t-distribution.

The at least one processor may be configured to arrange the start point of the voice segment of the other speaker before or after the end point of the voice segment of the speaker.

The at least one processor may be configured to arrange voice segments having a same index for each of the plurality of speakers, and in response to completing the arrangement of the voice segments having the same index, arrange voice segments having a next index.

The arranged voice segments may be labeled with a tag indicating which speaker's voice segment from among the plurality of speakers is.

The voice data generated by arranging the set number of voice segments for each of the plurality of speakers may be used for training for speaker diarization.

According to an embodiment of the disclosure, a computer-readable recording medium storing a program for implementing a voice data generation method, the voice data generation method may include: setting a number of a plurality of speakers to be used for generation of voice data; setting a number of voice segments for each of the plurality of speakers; and arranging the set number of voice segments for each of the plurality of speakers. The arranging of the set number of voice segments may include, based on an end point of a voice segment of a speaker of the plurality of speakers, determining a start point of a voice segment of another speaker.

The arranging of the set number of voice segments may include arranging the start point of the voice segment of the other speaker at a position spaced apart from the end point of the voice segment of the speaker by an arbitrary time interval.

The arbitrary time interval may be determined according to a probability distribution selected from a group of probability distributions including a normal distribution, a continuous uniform distribution, and a Student's t-distribution.

The arranging of the set number of voice segments may include arranging the start point of the voice segment of the other speaker before or after the end point of the voice segment of the speaker.

The arranging of the set number of voice segments may include arranging voice segments having a same index for each of the plurality of speakers, and in response to completing the arrangement of the voice segment having the same index, arranging voice segments having a next index.

The arranged voice segments may be labeled with a tag indicating which speaker's voice segment from among the plurality of speakers is.

Meanwhile, the above-described voice data generation method can be stored in the form of a recording medium storing computer-executable instructions. The instructions may be stored in the form of a program code, and when executed by a processor, the instructions may perform operations of the disclosed embodiments.

The recording medium may be implemented as a computer-readable recording medium, and may be a non-transitory computer-readable medium.

The computer-readable recording medium includes all kinds of recording media in which instructions which may be decoded by a computer are stored of, for example, a read only memory (ROM), random access memory (RAM), magnetic tapes, magnetic disks, flash memories, optical recording medium, and the like.

As is apparent from the above, according to the embodiments of the disclosure, a voice data generation method, a voice data generation apparatus and a computer-readable recording medium storing a program for implementing the voice data generation method can generate natural voice data similar to conversations among a plurality of actual speakers.

The voice data generated according to the disclosure can be used for training a speaker diarization model. The trained speaker diarization model can be used to separate voice sections for each speaker in voice data including utterances of a plurality of speakers.

By the above-described voice data generation method, voice data generation apparatus, computer-readable recording medium storing a program for implementing the voice data generation method according to the disclosure, a start point of a voice segment of a speaker can be arranged based on an end point of a voice segment of another speaker, thereby generating natural voice data like an actual conversation.

By training a speaker diarization model using the generated voice data, an accuracy of speaker diarization results can be improved, and training data can be more efficiently secured.

Although various examples have been described for illustrative purposes, those skilled in the art will appreciate that various modifications, additions and substitutions are possible, without departing from the scope and spirit of the disclosure.

What is claimed is:

1. A method performed by a computing device, the method comprising:
determining a number of a plurality of speakers to be used for voice data generation;
determining a number of voice segments for each of the plurality of speakers;
arranging the determined number of voice segments for each of the plurality of speakers, wherein the arranging of the determined number of voice segments comprises, based on an end point of a voice segment of a first speaker of the plurality of speakers, determining a start point of a voice segment of a second speaker; and
generating, based on the arranging, voice data.

2. The method of claim 1, wherein the arranging of the determined number of voice segments comprises arranging the start point of the voice segment of the second speaker at a position spaced apart from the end point of the voice segment of the first speaker by an arbitrary time interval.

3. The method of claim 2, wherein the arbitrary time interval is determined according to a probability distribution selected from a group of probability distributions, wherein the group of probability distributions comprises at least one of: a normal distribution, a continuous uniform distribution, or a Student's t-distribution.

4. The method of claim 2, wherein the arranging of the determined number of voice segments comprises arranging the start point of the voice segment of the second speaker before or after the end point of the voice segment of the first speaker.

5. The method of claim 1, wherein the arranging of the determined number of voice segments comprises arranging first voice segments of the plurality of speakers, wherein the first voice segments are associated with a first index, and
after completing the arranging of the first voice segments, arranging second voice segments of the plurality of speakers, wherein the second voice segments are associated with a second index.

6. The method of claim 1, wherein each of the arranged voice segments are labeled with a tag indicating a speaker of the plurality of speakers.

7. The method of claim 1, wherein the arranging of the determined number of voice segments comprises:
arranging a plurality of first voice segments of the plurality of speakers, wherein the plurality of first voice segments are associated with a first index, and wherein at least two of the plurality of first voice segments are arranged based on:
a first time offset associated with at least one probability distribution; and
an end point of a preceding one of the at least two of the plurality of first voice segments; and
arranging a plurality of second voice segments of the plurality of speakers, wherein the plurality of second voice segments are associated with a second index, and wherein at least two of the plurality of second voice segments are arranged based on:
a second time offset associated with the at least one probability distribution; and
an end point of a preceding one of the at least two of the plurality of second voice segments,
wherein a voice segment of the plurality of second voice segments that precedes the remaining voice segments of plurality of second voice segments is arranged based on:
a third time offset associated with the at least one probability distribution; and
an end point of a last voice segment of the plurality of first voice segments.

8. An apparatus comprising:
at least one processor; and
at least one memory storing instructions that, when executed by the at least one processor, cause the apparatus to:
determine a number of a plurality of speakers to be used for voice data generation;
determine a number of voice segments for each of the plurality of speakers;
arrange the determined number of voice segments for each of the plurality of speakers, wherein arranging the determined number of voice segments comprises, based on an end point of a voice segment of a first speaker of the plurality of speakers, determining a start point of a voice segment of a second speaker;
generate, based on the arranging, voice data; and
train, based on the generated voice data, a learning model associated with speaker diarization.

9. The apparatus of claim 8, wherein the instructions, when executed by the at least one processor, cause the apparatus to arrange the start point of the voice segment of the second speaker at a position spaced apart from the end point of the voice segment of the first speaker by an arbitrary time interval.

10. The apparatus of claim 9, wherein the arbitrary time interval is determined according to a probability distribution selected from a group of probability distributions, wherein the group of probability distributions comprises at least one of: a normal distribution, a continuous uniform distribution, or a Student's t-distribution.

11. The apparatus of claim 9, wherein the instructions, when executed by the at least one processor, cause the apparatus to arrange the start point of the voice segment of the second speaker before or after the end point of the voice segment of the first speaker.

12. The apparatus of claim 8, wherein the instructions, when executed by the at least one processor, cause the apparatus to arrange first voice segments of the plurality of speakers, wherein the first voice segments are associated with a first index, and
after completing arrangement of the first voice segments, arrange second voice segments of the plurality of speakers, wherein the second voice segments are associated with a second index.

13. The apparatus of claim 8, wherein each of the arranged voice segments are labeled with a tag indicating a speaker of the plurality of speakers.

14. The apparatus of claim 8, wherein the instructions, when executed by the at least one processor, cause the apparatus to arrange the determined number of voice segments by:
arranging a plurality of first voice segments of the plurality of speakers, wherein the plurality of first voice segments are associated with a first index, and wherein at least two of the plurality of first voice segments are arranged based on:
a first time offset associated with at least one probability distribution; and
an end point of a preceding one of the at least two of the plurality of first voice segments; and
arranging a plurality of second voice segments of the plurality of speakers, wherein the plurality of second voice segments are associated with a second index, and wherein at least two of the plurality of second voice segments are arranged based on:
a second time offset associated with the at least one probability distribution; and
an end point of a preceding one of the at least two of the plurality of second voice segments,
wherein a voice segment of the plurality of second voice segments that precedes the remaining voice segments of plurality of second voice segments is arranged based on:
a third time offset associated with the at least one probability distribution; and
an end point of a last voice segment of the plurality of first voice segments.

15. A computer-readable recording medium storing instructions that, when executed, cause:
determining a number of a plurality of speakers to be used for voice data generation;
determining a number of voice segments for each of the plurality of speakers;
arranging the determined number of voice segments for each of the plurality of speakers, wherein the arranging of the determined number of voice segments comprises, based on an end point of a voice segment of a first speaker of the plurality of speakers, determining a start point of a voice segment of a second speaker; and
generating, based on the arranging, voice data.

16. The computer-readable recording medium of claim 15, wherein the arranging of the determined number of voice segments comprises arranging the start point of the voice segment of the second speaker at a position spaced apart from the end point of the voice segment of the first speaker by an arbitrary time interval.

17. The computer-readable recording medium of claim 16, wherein the arbitrary time interval is determined according to a probability distribution selected from a group of probability distributions, wherein the group of probability distributions comprises at least one of: a normal distribution, a continuous uniform distribution, or a Student's t-distribution.

18. The computer-readable recording medium of claim 16, wherein the arranging of the determined number of voice segments comprises arranging the start point of the voice segment of the second speaker before or after the end point of the voice segment of the first speaker.

19. The computer-readable recording medium of claim 15, wherein the arranging of the determined number of voice segments comprises arranging first voice segments of the plurality of speakers, wherein the first voice segments are associated with a first index, and
after completing the arranging of the first voice segment, arranging second voice segments of the plurality of speakers, wherein the second voice segments are associated with a second index.

20. The computer-readable recording medium of claim 15, wherein each of the arranged voice segments are labeled with a tag indicating a speaker of the plurality of speakers.
